(19) United States
(12) Patent Application Publication
(10) Pub. No.: US 2017/0180505 A1
(43) Pub. Date: Jun. 22, 2017

(54) METHOD, COMPUTER-READABLE STORAGE DEVICE AND APPARATUS FOR STORING PRIVACY INFORMATION

(71) Applicant: AT&T Intellectual Property I, L.P., Atlanta, CA (US)

(72) Inventors: Venson Shaw, Kirkland, WA (US); Jin He, Fremont, CA (US); Richard Schmidt, Milton, GA (US); Mark Easley, Frisco, TX (US)

(21) Appl. No.: 14/975,220

(22) Filed: Dec. 18, 2015

(51) Int. Cl. H04L 29/08; G06Q 50/00; H04L 12/26

(52) U.S. Cl. CPC H04L 67/306; H04L 43/16; G06Q 50/01

(57) ABSTRACT

Methods, computer-readable storage media and apparatuses for privacy information management are disclosed. A processor stores privacy information of a user, receives over a communication network associated with the network service provider, an inquiry directed to the user from a business entity, the business entity having previously conducted a transaction with the user, the inquiry in a polar question format, determines an answer responsive to the inquiry from the privacy information, and provides over the communication network associated with the network service provider, the answer to the business entity when a threshold of a number of inquiries from the business entity has not been exceeded for a time period.

The present disclosure relates generally to communication networks and, more particularly, to methods, computer-readable storage devices and apparatuses for storing privacy information of a user and for providing analytics on the stored privacy information on behalf of the user.

### BACKGROUND

Consumers are becoming ever more protective of their personal data. For example, consumers are concerned with respect to identity theft and misuse of their personal data. However, although consumers are worried as to how their data will be used, consumers are nevertheless willing to provide consent to allow companies to use their personal data under certain scenarios, e.g., to receive product/services deemed important to the consumers, e.g., geo-location information pertaining to the consumers may be required to provide services that are location based. In other words, consumers are generally willing to give consent to the use of their personal data to support the innate functionality of a particular subscribed service.

On the flip side, companies are interested in accessing consumers' data (i.e., big data) to provide better services and/or to promote new business opportunities. This creates a tension between consumers who want to control how their personal data will be used and companies that want to access such big data to provide services to the consumers.

### SUMMARY

In one example, the present disclosure discloses methods, computer-readable storage media and apparatuses for privacy information management. For example, a processor stores privacy information of a user, receives over a communication network associated with the network service provider, an inquiry directed to the user from a business entity, the business entity having previously conducted a transaction with the user, the inquiry in a polar question format, determines an answer responsive to the inquiry from the privacy information, and provides over the communication network associated with the network service provider, the answer to the business entity when a threshold of a number of inquiries from the business entity has not been exceeded for a time period.

### BRIEF DESCRIPTION OF THE DRAWINGS

The teaching of the present disclosure can be readily understood by considering the following detailed description in conjunction with the accompanying drawings, in which:

FIG. 1 illustrates an example network related to the present disclosure;

FIG. 2 illustrates a user interface showing a user's preference as to how the user's privacy information is to be used in an analytic system;

FIG. 3 illustrates a flowchart of an example method for storing and using the user's privacy information in an analytic system in accordance with the present disclosure; and

FIG. 4 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses methods, computer-readable media and devices for storing privacy information of a user and for providing analytics on the stored privacy information on behalf of the user. Although the present disclosure is discussed below in the context of wireless access networks and an Internet Protocol (IP) network, the present disclosure is not so limited. Namely, the present disclosure can be applied to packet switched or circuit switched networks in general, e.g., Voice over Internet Protocol (VoIP) networks, Service over Internet Protocol (SoIP) networks, Asynchronous Transfer Mode (ATM) networks, Frame Relay networks, and the like.

In one example, the present disclosure provides a privacy information management service for storing privacy information of a user and for providing analytics on the stored privacy information on behalf of the user. It is often the case that consumers are requested to provide certain personal information to allow companies, e.g., service providers, manufacturers, retailers and the like, to utilize certain amount of their personal data in order to provide one or more innate functionalities. For example, a cellular service provider may request that a consumer consents to have his or her physical location information or data (broadly geo-location information) be used to provide the innate functionality of receiving cellular service. In other words, the cellular service provider must be able to determine the consumer's physical location in order to forward cellular calls to the consumer. Similarly, a mortgage company or a banking institution may request that a consumer consents to have his or her financial information or data be used and verified to receive the innate functionality of receiving a mortgage or a loan. In yet another example, a medical institution may request that a consumer consents to have his or her medical information or data be used and verified to receive the innate functionality of receiving a proper diagnosis of a potential aliment or disease. In yet another example, a media delivery service provider may request that a consumer consents to have his or her media viewing information or data be used and tracked to receive the innate functionality of receiving a notification of a future program that may be of interest to the consumer. In yet another example, a traffic notification service provider may request that a consumer consents to have his or her current location information or data be used and tracked to receive the innate functionality of receiving up to date traffic conditions on a route that the consumer is currently traveling on.

The above list of examples is only illustrative and not exhaustive. It is noted that consumers are becoming ever more protective of their personal data. For example, consumers are concerned with respect to identity theft and misuse of their personal data. However, as illustrated by the above examples, although consumers are worried as to how their data will be used, consumers are nevertheless willing to provide certain amount of personal information to allow companies to use their personal data under certain scenarios, e.g., to receive product/services deem important to the consumers. In other words, consumers are generally willing to give consent to the use of their personal data to support the innate functionality of a particular subscribed service.

The above examples also illustrate another reality of the modern world that consumers are facing. The reality is that consumers are often requested to provide their personal information in order to receive various services and/or products. Over a period of time, each consumer may have repeatedly provided personal information for use by numerous third party business entities in different fields. Thus, over a long period of time, each individual business entity may have a small amount of knowledge of the personal information for each user, e.g., a particular airline may know the seating preference of a user when the user books a flight with that particular airline, a particular hotel chain may know the type of room preference when the user reserves a room from that particular hotel chain, a restaurant chain may know the type of food preference when the user orders food from that particular restaurant chain, and so on. However, the amount of personal information provided to each business entity by the user is often limited only to the relevant services provided by each business entity. Thus, a user's preference for a type of food is often provided to a restaurant that the user has ordered a takeout, but is not provided to a stadium in which the user has attended to watch a football game.

On the flip side, companies are very interested in accessing consumers' data (i.e., big data) to provide better services and/or to promote new business opportunities. For example, business entities are often providing a main service that is supplemented by a plurality of secondary or axillary services. To illustrate, an airline is providing a transportation service that may provide axillary services such as a food service, e.g., food and drink items to be made available on the aircraft, and an entertainment service such as an on-board entertainment service for the duration of the flight. Similarly, a stadium is providing a sports viewing service that may provide axillary services such as a food service, e.g., food and drink items to be made available during a football game, and a souvenir purchase service, e.g., providing items to be purchased during the attendance of the sports event by the user.

However, such business entities are often not privy to the personal information as related to ancillary services. For example, when a user is ordering football tickets, the user is not willing or motivated to provide other personal information such as what the user likes to eat. The reasons as to the user's hesitation to provide such food preference may range from wanting to protect their personal information to not wanting to be bothered with numerous personal questions when ordering football tickets. The end result is that third party business entities will not be able to access such privacy information to improve their services, e.g., their ancillary services. In addition, even if a third party business entity is able to collect such personal information over a long period of time of interaction with the user, a “new” third party business entity will not be able to have such personal information until the new third party business entity is able to learn such personal information from the user through numerous interactions with the user. For example, airline A (e.g., favored by the user for flying) may know the user's preference as to seating, travel time, and food choices, but airline B (e.g., not favored by the user for flying) may have no such knowledge. As such, when the user books a flight with airline B, airline B will hot have the necessary personal information to better serve the user. The user will not likely be motivated to be bothered with having to provide any additional personal information to airline B. As such, airline B will not be able to tailor its services to better serve the user in the hope of generating more business from the user. In this illustrative scenario, both the user and the business entity are not benefiting from the use of user's privacy information which already exists in some form.

In one embodiment of the present disclosure, a privacy information management service is provided by a network service provider to receive and store privacy information from the user, which are then used in analytics to provide information to third party business entities on behalf of the user. The term “privacy information” comprises any personal information provided by the user, e.g., contact information (e.g., home address, work address, email addresses, home phone number, work phone number, mobile phone number and the like), and various personal preferences as related to lodging preferences, transportation preferences, eatery preferences, entertainment preferences, financial, preferences, medical preferences, and the like. It should be noted that the above list of privacy information is not exhaustive. Once the privacy information is received and stored by the network service provider, analytics can be performed on behalf of the user to interact with “inquiring” third party business entities.

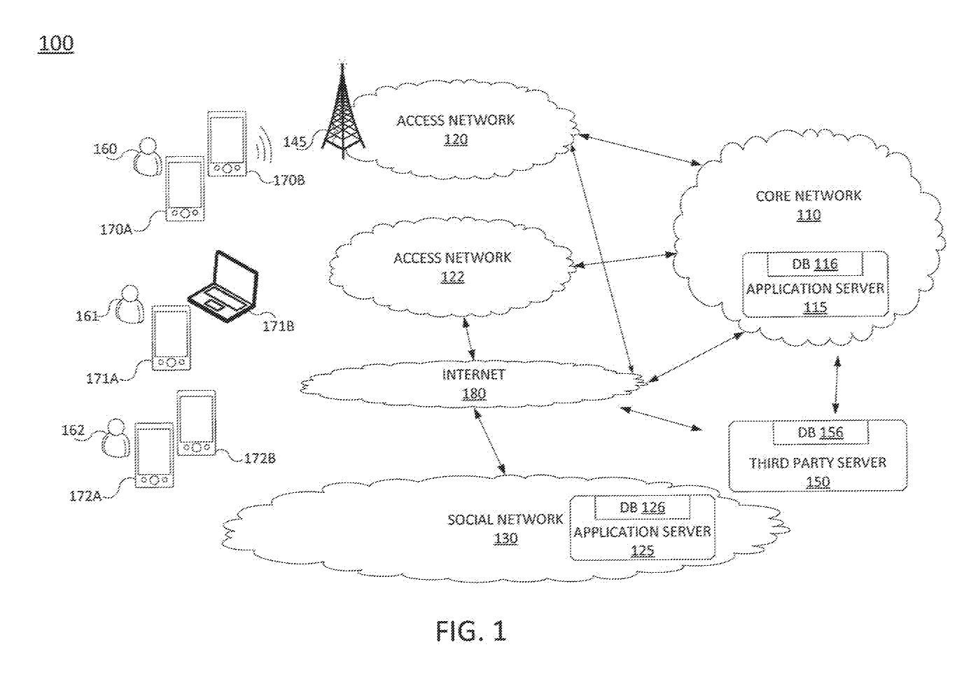

To aid in understanding the present disclosure, FIG. 1 illustrates a block diagram depicting one example of a communication network 100 suitable for performing or enabling the steps, functions, operations and/or features described herein. The overall communication network 100 may include any number of interconnected networks which may use the same or different communication technologies, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, and so forth. It should be noted that an IP network is broadly defined as a network that uses Internet Protocol to exchange data packets.

As shown in FIG 1, the communication network 100 connects endpoint devices 170A-172A and 170B-172B with each other and/or with one or more application servers via a core network 110, access networks 120 and 122, social network 130 and/or Internet 180. in one embodiment, core network 110, e.g., an IP network, interfaces with one or more of the access networks 120 and 122, and may also include interfaces to the Internet 180 and/or social network 130. Access network 120 may comprise a wireless access network (e.g., an IEEE 802.11/Wireless-Fidelity (Wi-Fi) network and the like) or a cellular access network, and may include a cellular base station and/or wireless access point 145. In one embodiment, access network 122 may comprise a PSTN access network, a cable access network, a wired access network and the like. In one embodiment, the access networks 120 and 122 and the core network 110 may be operated by different service providers, the same service provider or a combination thereof. Various interconnections between access networks 120 and 122, core network 110, Internet 180 and social network 130 are shown. In accordance with the present disclosure, it is contemplated that devices may utilize any one or a combination of such networks and interfaces in order to communicate with one another.

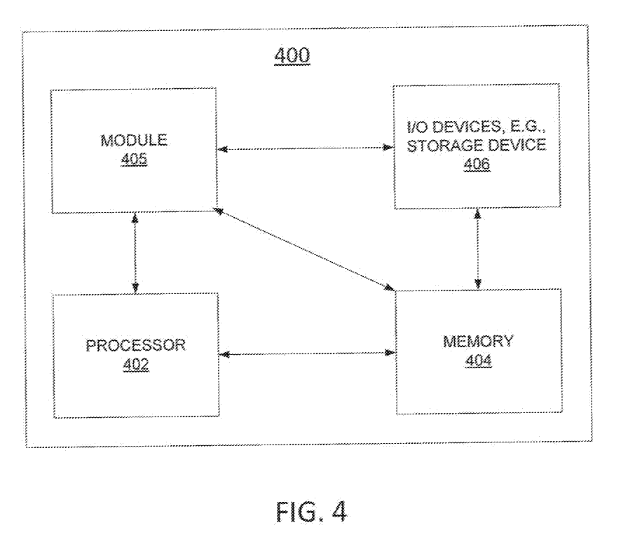

In one embodiment, the core network 110 may include an application server (AS) 115, e.g., a dedicated database server and a database (DB) 116. Although only a single AS 115 and a single DB 116 are illustrated, it should be noted that any number of application servers 115 or databases 116 may be deployed. In one embodiment, the AS 115 may comprise a programmed computing device as illustrated in FIG. 4 and discussed below. In one embodiment, the AS 115 is configured to perform steps, functions and/or operations of a privacy information management service, e.g., for using the stored privacy information to interact with a business entity on behalf of the user, accordance with the present disclosure. As such, DB 116 may store program code, data, files, and so forth to enable such functions. Thus, various embodiments am described herein as residing in or being performed in whole or in part by AS 115. For instance, AS 115 may receive and store the privacy Information of a plurality of users (e.g., subscribers of network services from the network service provider of network 102) and use the stored privacy information to answer inquiries presented by various third party business entitles on behalf of the users.

In one example, social network 130 may also include an application server (AS) 125 and a database (DB) 126, which may be the same or similar to AS 115 and DB 116 in the core network 110 and which are also suitable to perform at least the same functions. Similarly, in another embodiment one or more application servers (not shown), e.g., connected to Internet 180, may perform the same or similar functions. In other words, one or more application servers as deployed in a cloud environment may implement the functions as discussed herein.

In one embodiment, each of endpoint devices 170A-172A and 170B-172B may comprise an endpoint device configured for wireless or wired communication such as a personal computer, a laptop computer, a Personal Digital Assistant (PDA), a mobile phone, a smart phone, an email device, a computing tablet, a messaging device, a computing pair of glasses, and the like. As illustrated in FIG. 1, endpoint devices 170A-172A and 170B-172B may belong to and/or be associated with users 160-162, respectively. In particular, each of users 160-162 may have multiple associated endpoint devices. For example, user 160 may have both a personal smart phone (e.g., endpoint device 170A) as well as a work smart phone assigned by an employer (e.g., endpoint device 170B). Similarly, user 161 may have both a mobile phone (e.g., endpoint device 171A) as well as a personal computer (e.g., endpoint device 170B). In addition, user 162 may also have a personal smart phone (e.g., endpoint device 172A) as well as a work smart phone assigned by an employer (e.g., endpoint device 172B).

Notably, one or more of the users 160-162 may be a subscriber of access network 120 and/or core network 110. In other words, the user is already a customer of the network service provider that provides one or more communication services such as cellular phone services, voice over IP services, long distance telephony services, internet access services, data services, multimedia delivery services, and the like.

Accordingly, in one embodiment DB 116 to of AS 115 in the core network 110 may store privacy information of one or more of users 160-162, e.g., users who are also network subscribers. Taking user 160 as an example, the privacy information stored in DB 116 may include a name, billing address, service address, telephone number and email address associated with user 160. The privacy information may also include geographic location information regarding user 160. For example, location information may be determined from a source IP address associated with communications from user 160, global positioning system (GPS) information of a mobile device of the user, serving base station information, and so forth. The privacy information stored in DB 116 may also comprise biographic information, e.g., age, memberships in various groups, professional associations, and so forth, as well as calendar information for the user 160. The privacy information may also include a contact list of the user 160 that may comprise various contacts in various categories including: friends, family, colleagues, sports team members, hobby group members, and so forth. Finally, the privacy information may also include consent information or data associated with how the privacy information can be used in analytics in response to third party business inquiries.

Application server (AS) 115 may also access and/or store in DB 116 call detail records (CDRs) derived from telephone calls, emails, text messages, instant messages, multimedia messages (MMS), VoIP application usage, and the like which traverse various networks including core network 110, access networks 120 and 122, and so forth. Such CDRs may be gathered and accessed using any techniques which are known in the art and may be used for various purposes in accordance with the present disclosure, as described in greater detail below. Furthermore, AS 115 may also have access to various other services that the user may have subscribed to. For example, the user may also have one or more subscriptions to a multimedia content delivery service, e.g., requesting movies to be streamed to the user, an Internet access service, a data delivery service, a health wellness monitoring service, a financial planning service, a banking service, an online product purchase service, a home monitoring service, a home or business security service, a remote network access service and so on. It should be noted that the above list of subscribed services is only illustrative, but is not intended to be exhaustive.

In turn, Application server (AS) 115 may also access and/or store in DB 116 the consents as to the use of the user's privacy information in any one of the subscribed services. In other words, Application server (AS) 115 may serve as a centralized platform for storing the consents as to the use of the user's privacy information. This allows the Application server (AS) 115 to perform analytics on the user's privacy information as part of the privacy information management service provided to the user as further discussed below. Furthermore, Application server (AS) 115 may also enhance the user's data experience in terms of privacy information management as discussed below.

In addition, each of the users 160-162 may participate in social networking via social network 130. Thus, each of the users 160-162 may have a social network privacy information that includes: posts and messages of the user, biographic information of the user, information on contacts of the user and/or other participants of the social network with whom the user has Interacted, location/check-in information of the user, and so forth. In one example, the social network privacy information of each of the users 160-162 may be stored in database (DB) 126 of application server (AS) 125. Collectively, the information stored in DB 126 may be referred to as social network information and may be used for supplementing the privacy information as stored by AS 115 in DB 116.

For instance, application server (AS) 115 may access the social network information from AS 125/DB126 and use such information as an alternative to or in conjunction with stored privacy information in DB 116 and call detail record information available to AS 115 to automatically respond to inquiries presented by third party business entities. For example, the user may have certain subscription to services that are provided or identified via the social network, which may further have associated privacy information of the user. Such privacy information of the user can be extracted from the social network by AS 115 and stored in the DB 116 if consent is provided by the subscriber to perform such extraction, thereby saving user time in having to provide privacy information again to AS 115.

Alternatively, in one example privacy information of the user can be extracted from the core network by AS 125 and stored in the DB 126. In other words, the functions or operations of the present disclosure can be deployed in the AS 125 of the social network as well.

FIG. 1 also shows a third party server 150 with a DB 156, which may be operated by a third party business entity (broadly a business entity), e.g., a hotel, a motel, a bed and breakfast establishment, an airline, a bus carrier company such as Greyhound lines™, a train carrier company such as Amtrak®, a restaurant, a bakery, a deli, a theater, a sports team, a sports ticket outlet, a health club, a medical service provider, a hospital, a bank, a mortgage company, a retailer or vendor for providing a product to the user, e.g., a department store, a supermarket, an online retailer and so on. It should be noted that although only one third party server 150 is shown in FIG. 1 for clarity reasons, any number of third party servers can be represented in FIG. 1.

Furthermore, it should be noted that the network 100 has been simplified. For example, the network 100 may include other network elements (not shown) such as border elements, routers, switches, policy servers, security devices, gateways, a content distribution network (CDN), firewalls, and the like. Thus, FIG. 1 is only intended to illustrate one example environment in which embodiments of the present disclosure may be employed.

In one embodiment, the user provides privacy information to the communication network operated by the network service provider to be managed via a privacy information management service. Privacy information may comprise: 1) geo-location information, e.g., the current physical location of the user, 2) multimedia content consumption information, e.g., the type of content such as movies and/or programs watched and preferred by the user, 3) viewing schedule information, e.g., time schedule that the user is watching or prefers to watch the content, e.g., 9:00 pm on a Sunday and so on, 4) medication information, e.g., medication purchased by the user, 5) medical Information, e.g., medical conditions associated with the user, medical services used by the user, e.g., hospitals and medical clinics, 6) delivery of product information, e.g., the time and day that a product is delivered to the user, 7) financial information, e.g., banking information, mortgage information, credit information, credit card information and the like, 8) biometric information, e.g., the current body temperature of the user, the current weight of the user, the current shoe size of the user, the current height of the user, and the like, 9) appointment information of the user, e.g., events on a calendar of the user, 10) communication information, e.g., individuals that the user has communicated with via phone calls, emails, text messages, the preferred modality of communication, e.g., texting, emails, cellular calls, and the like, 11) contact information, e.g., phone numbers of contacts (e.g., friends, family and co-workers), email addresses of contacts, home addresses of contacts, 12) lodging preferences (e.g., types of hotels, brand of hotel chains, types of rooms, smoking or non-smoking rooms, and so on), 13) traveling preferences (e.g., types of transportation mode (e.g., planes, trains, buses, or types of rental cars), brand of airlines, bus carriers, train carriers, types of seating, types of travel locations, types of landmarks to be visited when travelling, and so on), 14) eatery preferences (e.g., types of restaurants, types of food, types of spices to be applied to food, range of costs willing to be incurred for food and drink, locations of eateries), 15) entertainment preferences (e.g., types of sports, types of shows, types of movies, types of television programming, types of music), and so on. Again, this list of privacy information is only illustrative and should not be deemed to be an exhaustive list.

Given the need of the innate functionality of a user procuring various services and making various product purchases, a user may have to provide certain portions of the privacy information to be used by one or more business entities. Thus, each of many business entities may have obtained a very small subset of the privacy information for a user by interacting with the user via one or more business transactions, but no single business entity would likely have the entire set of privacy information for each user.

For example, purchasing a product online may require the user to provide consent as to the use of: 1) the user's credit card information to complete the transaction, and 2) the user's email address to receive product delivery tracking information, e.g., a tracking number of a delivery service. In another example, purchasing a medical boot may require the user to provide consent as to the use of: 1) the user's medical records to ascertain the prescription for the purchase of the medical boot, and 2) the user's biometric information such as the size of the user's foot so that a properly sized medical boot can be determined. Such consents are often freely provided by the users since they pertain to the innate functionalities of the provided services.

However, the privacy information provided in the above examples can be leveraged to provide a privacy information management service to the user. For example, the user's email address can be used to receive a confirmation of a purchase, to receive a notification that a product has been shipped, to receive a notification that a product is back ordered, to receive a notification that a flight has been canceled due to weather, to receive a notification that a Broadway show has been canceled, to receive a notification that a flight upgrade is available, and so on. In another example, the user's lodging preference can be used to receive a notification that a room upgrade is available. In another example, the user's entertainment preference can be used to receive a notification that a ticket is available for a particular sports event. However, business entities without access to such privacy information will not be able to ascertain the numerous different preferences of a very large number of users. In turn, the business entities will likely bombard all users with various business opportunities. In turn, users are fatigue from receiving so many unfocused solicitations such that many users may setup filters to block out such unwanted solicitations. However, not all solicitations are unwanted by the users. The users may simply be inundated with so many solicitations on such a regular basis that users are no longer interested in reading all of the solicitations. As a result, the business entities are not getting the benefit of their marketing efforts and the users are not getting the benefit of having their preferences addressed and met.

In one embodiment, the present disclosure provides a privacy information management service offered by a network service provider. For example, a user will provide privacy information to be stored on a communication network of the network service provider. For example, the privacy information can be manually provided to the network service provider, e.g., answering a survey with a plurality of questions. In another example, the privacy information can be. automatically extracted by the network service provider, e.g., monitoring the user's commercial transaction activities (e.g., commercial transactions in procuring goods or services) over the communication network, monitoring the user's communication activities (e.g., email communications, text messaging activities, phone records, and the like), and so on. In other words, if the network service provider is providing Internet access service to the user, then the network service provider may monitor the transactions made by the user over the Internet. Similarly, if the network service provider is providing cellular service or data service to the user, then the network service provider may monitor the communication activities and transactions made by the user over the cellular service or data service. Any such automatic monitoring must be in accordance with receiving an affirmative consent by the user as part of the privacy information management service. This allows the user to consolidate his or bar privacy information in one centralized platform. The network service provider is then tasked with performing analytics on the privacy information to respond to inquiries received from third party business entities.

For example, a user has reserved a hotel room at a vacation spot for $200 per night from hotel chain A. The hotel chain A has a limited number of premium rooms at $500 that have yet to be reserved and will likely be unused. Hotel chain A would like to avoid such lost opportunities. In one embodiment, hotel chain A may sand an offer of the premium room at a reduced amount of $350 to the user. However, the offer is not sent directly to the user, but instead, is sent to the AS 115 acting on behalf of the user. The network service provider having access to the user's privacy information is in a position to answer on behalf of the user. For example, the user may have entered manually as to the user's preference or willingness to pay a certain range of dollar amount for a hotel room, e.g., between $125-$275. Alternatively, the network service provider may have deduced the range by monitoring previous hotel room transactions made by the user. As such, the network service provider will be able to answer on behalf of the user. In one illustrative embodiment, the business entity is permitted to only provide inquiries in the form of a polar question, e.g., “yes” or “no” question (or positive or negative question), e.g., “Is John Doe willing to upgrade to a premium room for $350?” In turn, in one embodiment, the network service provider is authorized to only respond with a positive or negative reply, e.g., “No, John Doe is not willing to upgrade to a premium room for $350,” or “Yes, John Doe is willing to upgrade to a premium room for $350” or just “No” or “Yes.” The use of polar questions limits the ability of the business entity to deduce the user's exact preference as to paying for lodging cost since it would not be to the user's benefit in divulging this privacy information. In one example, the user and/or the network service provider may limit the business entity from presenting a large number of successive polar question inquiries, e.g., “Is John Doe interested in paying for the premium room at $345,” “at $340,” “at $335,” “at $330,” “at $325” and so on.

In one example, the network service provider will charge the business entity a service charge for responding to the inquiry. For example, each inquiry will incur a charge of $0.10, $0.20, $0.30 and the like to the business entity. This service charge provides several benefits. First, the business entity will have to price the opportunity appropriately so that the “inquiry” cost will not be too great, if inquiries are to be sent out repeatedly. Second, the service charge serves as a deterrent for business entities that are inclined to send a large number of inquiries to uncover the user's true preferences. Third, the service charge will provide a financial benefit to the network service provider for operating the privacy information management service, e.g., the service can be provided to the user free of any charge and the cost of operating this service can be bore by the business entities making the inquiries. Finally, in one example, the network service provider may provide a portion (e.g., a rebate) of the collected “inquiry” cost to the user. For example, if the network service provider collected $50 over a period of six (6) months from various business entities making inquiries to the user, then the network service provider may provide a credit to the user such as a portion of the $50, e.g., 10%, 20%, 30% and so on.

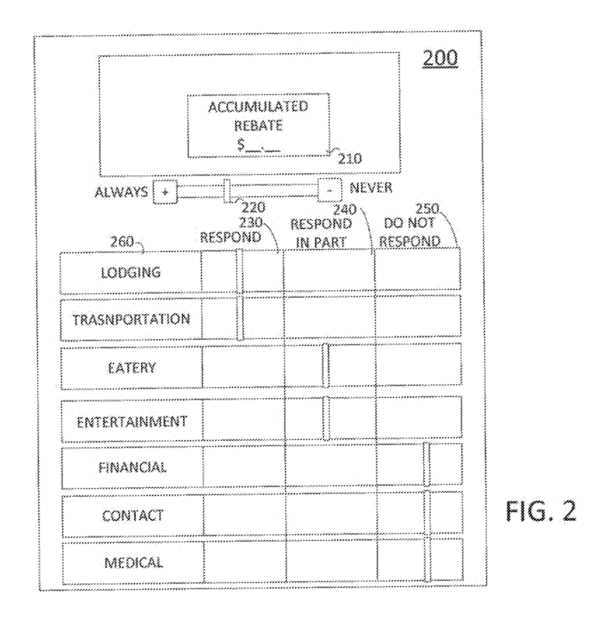

FIG. 2 illustrates a user interface or screen 200 showing a user's preference as to how the user's privacy information is to be used in an analytic system operated by the network service provider. In one embodiment, various privacy information or preferences will be categorized into different classes 260, e.g., “lodging,” “transportation,” “eatery,” “entertainment,” “financial,” “contact,” and “medical.” It should be noted that these illustrative classes are only Illustrative and not intended to be exhaustive. Once the user's preferences are categorized into each of these classes, the user via interface 200 will be able to dictate how these different classes of privacy information will be used to respond to business inquiries, i.e., the user may select a “response parameter” that dictates what type of inquiries will be responded to with answers.

In one illustrative example, the user has selected the tap “respond” 230 for classes of “lodging” and “transportation.” This indicates that the user is willing to have the network service provider responds to inquiries pertaining to the user's preference as to lodging preferences and transportation preferences. For example, if the inquiries are related to the availability for an upgrade to a hotel room or a flight, then the network service provider is authorized to respond on the user's behalf.

Similarly, the user has selected the tap “respond in part” 240 for classes of “eatery” and “entertainment.” This indicates that the user is willing to have the network service provider responds to inquiries pertaining to the user's preference as to eatery preferences and entertainment preferences under certain conditions, e.g., the timing of the inquiries, the underlying reasons for the inquiries, and so on. For example, if the inquiries are related to the availability for a change of venue for a large dinner gathering for a substantial reduction in cost, then the network service provider is authorized to respond on the user's behalf, only if the offer did not arrive too close to the actual date of the dinner gathering, e.g., within a week of the dinner gathering. In other words, the user may not have sufficient time to inform all of the guests of the venue change and, as such, would not entertain any changes in the dinner plan once it is within the time frame of one week.

Finally, the user has selected the tap “do not respond” 250 for classes of “financial”, “contact” and “medical.” For example, if the inquiries are related to whether the user wants an equity loan (financial preference), whether the user knows a person by the name Jane Doe (contact preference), or whether the user has been admitted to XYZ hospital (medical preference), then the network service provider is not authorized to respond on the users behalf. In this example, the user may deem such privacy information to be too sensitive to be shared with any third parties.

In one embodiment a sliding bar 220 can be used by the user to broadly select a global tap for the response parameter. In other words, instead of selecting an individual setting for the response parameter for each class, the global tap is applicable to all of the classes. For example, by selecting the global tap to “always,” all inquiries directed to the user will receive an answer or a response. For another example, by selecting the global tap to “never,” all inquiries directed to the user will never receive an answer or a response. Finally, by selecting the global tap to a point between “always” and “never,” some inquiries directed to the user will receive an answer or a response under some conditions. The conditions can be defined by the user and/or the network service provider. Thus, the global tap allows the user to quickly select a setting for the response parameter.

In one embodiment, the screen 200 also comprises a field 210, e.g., an accumulated rebate field, to show the user an amount of rebate that is currently available to the user. As discussed above, if the network service provider is charging a fee to respond to the business entities, then the network service provider may provide a portion of the collected charges to the user.

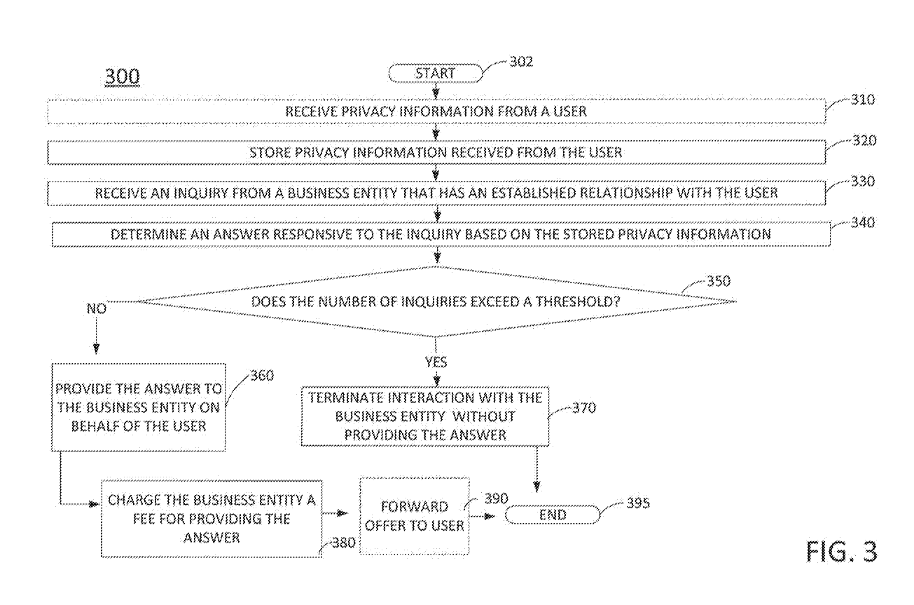

FIG. 3 illustrates a flowchart of an example method 300 for storing and using the user's privacy information, e.g., providing a privacy information management service, in an analytic system in accordance with the present disclosure. In one embodiment, steps, functions and/or operations of the method 300 may be performed by a network-based device, e.g., application server 115 or application server 125, in FIG. 1. In another embodiment, steps, functions and/or operations of the method 300 may he performed by a user endpoint device, e.g., endpoint device 170A or 170B in FIG. 1, or by a network-based device in conjunction with a user endpoint device. In one embodiment, the steps, functions, or operations of method 300 may be performed by a computing device or system 400, and/or processor 402 as described in connection with FIG. 4 below. For illustrative purpose, the method 300 is described in greater detail below in connection with an embodiment performed by a processor, such as processor 402. The method begins in step 302 and proceeds to step 310.

At optional step 310, the processor receives privacy information directly from the user. However, as discussed above, the privacy information can be extracted instead over time from activities (e.g., communication activities and/or transaction activities) conducted by the user over the communication network operated by the network service provider. Alternatively, the privacy information can also be obtained from an application server of a social network. In other words, some of the privacy information may already exist in a user profile of a social network account of a social network service provider. The user can then authorize the network service provider to directly obtain the user profile from the social network service provider.

At step 320, the processor stores privacy information received directly from the user or through other mechanisms. For example, the privacy information for a plurality of users can be stored in DB 116 under the control of application server 115.

At step 330, the processor receives an inquiry (e.g., in a polar question format) from a business entity directed to the user. For example, a business entity is an entity that is formed to conduct business with the general public. As such, the term “business entity” does not encompass individuals not conducting any business with the user. For example, a stranger, a friend, a coworker, or a family member may not be allowed to submit an inquiry in which an answer or a response will be provided. For example, the network service provider may only provide an answer or a response if the requester is a legitimate business concern, e.g., the source address can be checked to determine whether the source address belongs to a legitimate business entity, or the network service provider may have a white list of legitimate business entities. In one embodiment, the business entity is a business entity that is currently or has previously conducted a business transaction with the user. For example, the inquiry may have originated from a bank that the user currently has a bank account, or from a hotel chain that the user had previously stayed for vacation or business travel. Thus, in one embodiment, the network service provider is authorized to only interact with “established business entities” that have previously conducted a transaction with the user (e.g., a transaction related to a service or to the purchase of an item). Fielding inquiries from such “established business entities” will likely produce a benefit to the user in that the user has previously chosen to do business with these “established business entities.” Thus, there is less likelihood that the user will find fault in providing a response to these “established business entities.” Responding to “non-established business entities” that have never conducted any business transactions with the users may provide less benefits to the user in that these “non-established business entities” may be disfavored by the user.

At step 340, the processor determines a response to the inquiry based on the stored privacy information. In one example, the user may have provided a definitive preference that can be used to respond to the inquiry, e.g., the user has indicated that he is willing to spend up to $400 for an upgrade to a premium room and the offer is $350 for the premium room. Thus, the determined response to the inquiry would be “yes” or “affirmative.” Alternatively, the network service provider may apply analytics to the stored privacy information, e.g., searching and analyzing previous hotel reservations to determine what were the range of costs incurred by the user for reserving a premium room. For example, the user within the last 5 years has reserved a premium room on two occasions from the same hotel chain and the costs were between $425-$325.

At step 350, the processor determines whether the number of inquiries for a business entity has exceeded a predefined threshold. For example, the predefined threshold can he set to one (1) inquiry per day from each business entity, five (5) inquiries per day from each business entity, ten (10) inquiries per week from each business entity, twenty (20) inquiries per month from each business entity, fifty (50) inquiries per year from each business entity, and so on. In other words, the processor will provide the answer over the communication network associated with the network service provider to the business entity when a threshold of a number of inquiries from the business entity has not been exceeded for a time period. If the answer is positive at step 350, the processor will proceed to step 370 where the processor will terminate interaction with the business entity without providing a response or answer to the inquiry. If the answer is negative at step 350, the processor will proceed to step 360 where the processor will provide a response or answer to the inquiry.

At step 380, the processor will charge the business entity a fee for providing the answer or response. If the user is entitled to a rebate based on the collected be, then a database will be updated in step 380 as well to track the user's rebate amount.

At optional step 390, the processor will toward an offer consistent with the inquiry to the user. For example, the inquiry “Is John Doe willing to upgrade to a premium room for $350?” (serving as an offer in this example) will be sent to an endpoint device of the user, e.g., a computer, a laptop, a tablet, or a mobile phone. In other words, some inquiries are already in the form of an offer. Alternatively, once the business entity receives the positive or affirmative response, the business entity may send a formal offer instead of a simple Inquiry to the user, e.g., via the network service provider's network service or through another communication medium, e.g., to the user's social networking site. Method 300 ends in step 395.

It should be noted that although not specifically specified, one or more steps, functions or operations of the method 300 may include a storing, displaying and/or outputting step as required for a particular application. In other words, any data, records, fields, and/or intermediate results discussed in the respective methods can be stored, displayed and/or outputted to another device as required for a particular application. Furthermore, steps or blocks in FIG. 3 that recite a determining operation or involve a decision do not necessarily require that both branches of the determining operation be practiced. In other words, one of the branches of the determining operation can be deemed as an optional step. In addition, one or more steps, blocks, functions or operations of the above described method 300 may comprise optional steps, or can be combined, separated, and/or performed in a different order from that described above, without departing from the example embodiments of the present disclosure.

As such, the present disclosure provides at least one advancement in the technical field of privacy information management. This advancement allows for a dedicated system to use the user's privacy information as a mechanism to provide an answering service to solicitations from established business entitles associated with the user. The present disclosure also provides a transformation of data. For example, privacy information is transformed into a mechanism to answer inquiries directed to the user.

Finally, embodiments of the present disclosure improve the functioning of a computing device, e.g., a server and/or a user endpoint device. Namely, a server or endpoint device dedicated for providing consent management services is improved.

FIG. 4 depicts a high-level block diagram of a computing device suitable for use in performing the functions described herein. As depicted in FIG. 4, the system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for providing a privacy information management service, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 300 as discussed above is implemented in a distributed or parallel manner for a particular illustrative example, i.e., the steps of the above method 300, or the entire method 300 is implemented across multiple or parallel computing device, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 300. In one embodiment, instructions and data for the present module or process 405 for providing a privacy information management service (e.g., a software program comprising computer-executable instructions) can be loaded into memory 404 and executed by hardware processor element 402 to implement the steps, functions or operations as discussed above in connection with the illustrative method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived in a programmed processor or a specialized processor. As such, the present module 405 for utilizing a consent valuation (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method comprising:
storing, by a processor of a network service provider, privacy information of a user;
receiving, by the processor and over a communication network associated with the network service provider, an inquiry directed to the user from a business entity, the business entity having previously conducted a transaction with the user, the inquiry in a polar question format;
determining, by the processor, an answer responsive to the inquiry from the privacy information; and
providing, by the processor and over the communication network associated with the network service provider, the answer to the business entity when a threshold of a number of inquiries from the business entity has not been exceeded for a time period.

2. The method of claim 1, wherein the privacy information is received from the user.

3. The method of claim 1, wherein the privacy information is extracted from a user profile obtained from a social network.

4. The method of claim 1 s wherein the privacy information is extracted from activities conducted by the user over the communication network.

5. The method of claim 4, wherein the activities comprise communication activities.

6. The method of claim 4, wherein the activities comprise commercial transaction activities.

7. The method of claim 1, further comprising:
forwarding, by the processor and over the communication network associated with the network service provider, the inquiry to an endpoint device of the user.

8. A non-transitory computer-readable storage medium storing instructions which, when executed by a processor of a network service provider, cause the processor to perform operations, the operations comprising:
storing privacy information of a user;
receiving over a communication network associated with the network service provider, an inquiry directed to the user from a business entity, the business entity having previously conducted a transaction with the user, the inquiry in a polar question format;
determining an answer responsive to the inquiry from the privacy information; and
providing over the communication network associated with the network service provider, the answer to the business entity when a threshold of a number of inquiries from the business entity has not been exceeded for a time period.

9. The non-transitory computer-readable storage medium of claim 8, wherein the privacy information is received from the user.

10. The non-transitory computer-readable storage medium of claim 8, wherein the privacy information is extracted from a user profile obtained from a social network.

11. The non-transitory computer-readable storage medium of claim 8, wherein the privacy information is extracted from activities conducted by the user over the communication network.

12. The non-transitory computer-readable storage medium of claim 11, wherein the activities comprise communication activities.

13. The non-transitory computer-readable storage medium of claim 11, wherein the activities comprise commercial transaction activities.

14. The non-transitory computer-readable storage medium of claim 8, the operations further comprising:
forwarding over the communication network associated with the network service provider, the inquiry, to an endpoint device of the user.

15. A device comprising:
a processor of a network service provider; and
a computer-readable medium storing instructions which, when executed by the processor, cause the processor to perform operations, the operations comprising:
storing privacy information of a user;
receiving over a communication network associated with the network service provider, an inquiry directed to the user from a business entity, the business entity having previously conducted a transaction with the user, the inquiry in a polar question format;
determining an answer responsive to the inquiry from the privacy information; and
providing over the communication network associated with the network service provider, the answer to the business entity when a threshold of a number of inquiries from the business entity has not been exceeded for a time period.

16. The device of claim 15, wherein the privacy information is received from the user.

17. The device of claim 15, wherein the privacy information is extracted from a user profile obtained from a social network.

18. The device of claim 15, wherein the privacy information is extracted from activities conducted by the user over the communication network.

19. The device of claim 18, wherein the activities comprise communication activities or commercial transaction activities.

20. The device of claim 15, the operations further comprising:
forwarding over the communication network associated with the network service provider, the inquiry to an endpoint device of the user.
